(19) United States
(12) Patent Application Publication
(10) Pub. No.: US 2026/0027532 A1
(43) Pub. Date: Jan. 29, 2026

(54) SOL-GEL METHOD FOR MANUFACTURING HOLLOW BEADS

(71) Applicant: GAMMA TECH, Grenoble (FR)

(72) Inventor: Tarek Fathallah, Crolles (FR)

(73) Assignee: GAMMA TECH, Grenoble (FR)

(21) Appl. No.: 18/997,418

(22) PCT Filed: Jul. 21, 2023
(86) PCT No.: PCT/EP2023/070243

§ 371 Date: Jan. 21, 2025

(30) Foreign Application Priority Data
Jul. 22, 2022 (FR) FR2207545

(51) Int. Cl. B01J 2/04

(52) U.S. Cl. CPC B01J 2/04

(57) ABSTRACT

The method for forming beads (1) by the sol-gel
method includes a) forming liquid drops (12) from a sol-gel solution (2), the drops being formed at a distance from a receptacle (10);
receptacle (10); then b) displacing the drops through a gaseous medium to the receptacle, the gaseous medium being conducive to gelation and possibly drying of the drops, so that the drops solidify progressively during their displacement towards the receptacle, so as to form beads;
beads, c) collecting the beads on the receptacle, the beads being sufficiently solidified not to deform under their own weight when they reach the;
receptacle; and d) extracting dried beads from the receptacle.

### PRIOR ART

Sol-gel methods are known to enable low-temperature production of ceramics or glasses with high purity and good homogeneity compared with conventional high-temperature methods.

In cell culture, microbeads are frequently used to form microcarriers intended to be placed in suspension in a culture medium. Microcarriers often take the form of microbeads, made of glass, plastic or an organic compound such as a polymer (e.g. polystyrene or a polysaccharide).

Generally, the microbeads have previously undergone a surface treatment, known as surface functionalization, to promote cell grafting. The aim is to promote cell attachment or adhesion. Microcarriers are frequently used for growing adherent cells. They act as supports on which cells can grow and multiply. Functionalization enables the application of a compound promoting cell grafting. This may be a biological compound (for example collagen, gelatin, elastin, Poly-D-Lysine, fibronectin), or a molecule providing positive or negative charges on the surface (for example cationic trimetylammonium or diethylaminoethyl). Document WO2021/140129 describes a method for forming sol-gel microdisk-type supports, in particular for cell culture applications. The method involves depositing droplets of a sol-gel solution on a support. The droplets flatten on the support and then solidify through gelation/drying.

The publications Kim N. K et al, “Fabrication of hollow silica aerogel spheres by a droplet generation method and sol-gel processing”, and Kim K. et al “Hollow Silica Spheres of Controlled Size and Porosity by sol-gel processing” describe methods enabling hollow beads to be formed using a sol-gel method. However, the method requires a specific nozzle, which limits the bead production yield.

KR10 2018 0051263 describes a method for forming solid beads by pyrolysis. The method is carried out at high temperature, the optimum temperature being 800° C.

FR2073260 describes a method for pyrolytically forming hollow beads from a solution comprising a precursor and a blowing agent. The precursor is configured to form a metal oxide when subjected to pyrolysis. Under the effect of pyrolysis, the blowing agent releases a gas under the effect of temperature. The pyrolysis temperature is between 300° C. and 1200° C.

US20170342274 describes a method for forming mesoporous particles containing an anti-corrosion agent. The method involves nebulizing a solution containing a surfactant. The surfactant is incorporated following a gelation phase of a sol-gel solution. The result is the formation of mesoporous particles, i.e. solid particles with a three-dimensional inorganic or hybrid organic-inorganic network. The particles are formed by pyrolysis, at a temperature of between 120° C. and 400° C.

The inventor proposes an innovative, easy-to-implement method for the collective production of sol-gel beads or microbeads at low temperature. The method makes it possible to simultaneously produce a large number of sol-gel beads or microbeads, while controlling bead shape and diameter, at low cost. The beads formed can be used in cell culture, but also for a variety of other applications, as described below.

### DESCRIPTION OF THE INVENTION

A first object of the invention is a sol-gel bead formation method, comprising:
a) formation of liquid droplets from a sol-gel solution, the droplets being formed at a distance from a receptacle;
b) following step a), displacement of the droplets through a gaseous medium to the receptacle, the gaseous medium being conducive to gelation and possibly drying of the drops, so that the droplets solidify progressively during their displacement towards the receptacle, to form beads;
c) collection of the beads on the receptacle, the beads being sufficiently solidified not to deform under their own weight when they reach the receptacle;
d) extraction of dried beads from the receptacle.

The method may include an additional drying phase e) for each bead on the receptacle.

The gaseous medium may comprise air. The gaseous medium can be placed under partial vacuum.

According to one possibility:
in step a), each drop formed is hollow, forming a sol-gel solution bubble;
step b) results in the formation of hollow beads.

The sol-gel solution may contain a surfactant.

Optionally, during step a),
each drop is expelled through a dispenser nozzle;
a feed gas is added to the sol-gel solution in the nozzle.

The dispenser can be a nebulizer or a sprayer.

According to one possibility, in step a) the diameter of each droplet is less than 10 mm or 2 mm or 1 mm

Optionally, in step a), the diameter of each droplet is greater than 100 nm or 1 μm.

According to one possibility, step a) is carried out by spraying or nebulization.

A second object of the invention is a bead made of sol-gel material, obtained by applying a method according to the first object of the invention.

A third object of the invention is a method for forming a sol-gel bead, comprising:
i) formation of liquid droplets from a sol-gel solution, the droplets being formed at a distance from a receptacle;
ii) following step i), moving the droplets to the receptacle;
iii) collection of beads in receptacle;
the method being characterized in that the receptacle comprises a liquid, that promotes gelation of the beads, the method comprising a step iv) of extracting the beads from the receptacle and drying the beads thus extracted.

The method according to the third object of the invention may include the technically compatible features of the method according to the first object of the invention.

The invention will be better understood after reading the description of embodiments given in the remainder of the description with reference to the figures listed below.

### FIGURES

FIG. 1 shows a schematic diagram of a bead resulting from the invention.

FIG. 2 shows a first embodiment of the invention.

FIG. 3 shows the main stages of the invention.

FIG. 4 shows a second embodiment of the invention.

FIG. 5 shows a variant of the first or second design.

FIG. 6 is a photograph of solid beads obtained using the first embodiment of the invention.

FIG. 7 is a photograph of hollow beads obtained using the second embodiment of the invention.

### DESCRIPTION OF PARTICULAR EMBODIMENTS

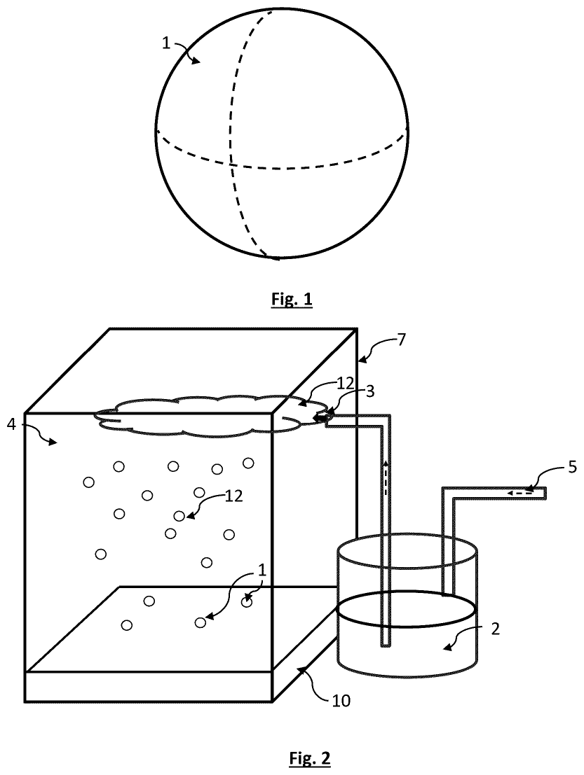

FIG. 1 shows an example of a bead according to the invention. The bead is made of a sol gel material. It has a diameterΦ, less than or equal to 20 mm, and preferably less than or equal to 10 mm, and more preferably less than or equal to 1 mm. The diameterΦ is preferably between 100 nm and 1 mm, and even more preferably between 1 μm and 1 mm or between 10 and 20 μm and 100 μm or 500μ m.

The bead can be used for cell culture applications, as a substitute for the glass or polymer beads described in connection with the prior art. Other types of application are also possible, as described at the end of the description

Preferably, each bead obtained by a method according to the invention is transparent. The method can be used to form solid beads or hollow beads. A hollow bead corresponds to a bubble surrounding a gaseous core.

Beads according to the invention are obtained using a sol-gel method, short for solution-gelation. This is a chemical method known to those skilled in the art, making it possible to manufacture glasses or ceramics at low temperature. Such a method involves the use of a sol-gel solution, comprising:
a molecular metal or metalloid precursor, for example an organometallic compound or a metal salt;
an organic solvent;
water;
an acid or base catalyst.

In the presence of water or water vapor, a network of oxides forms through hydrolysis-condensation reactions, trapping the organic solvent so as to form a gel. The gel is then dried to remove the organic solvent. Drying can be evaporative, at or at a pressure less or equal to atmospheric pressure, to form a dry gel, usually referred to as a xerogel, in the form of a monolithic solid.

The molecular precursor may, for example, be an organometallic metal or metalloid compound, for example a metal alkoxide of the formula M (OR) n, where M is a metal or metalloid, and R is an organic group.
The metal M may be a transition metal or a lanthanide, for example Ti, V, Cr, Mn, Fe, Co, Ni, Cu, Zn, Y, Zr, Nb, Mo, Ru, Rh, Pd, Ag, Cd, Hf, Ra, W, Re, Os, Ir, Pt, La, Ce, Pr, Nd, Sm, Eu, Gd, Tb, Dy, Er, Yb, Al, Ga, In, Ge, Sn, Pb.
The metalloid element can be chosen from Si, Se, Te.
R can be an alkyl group, comprising for example between 1 to 10 carbon atoms, or a phenyl group.
n is a natural number corresponding to the number of ligands bonded to M, which corresponds to the valency of M.

The molecular precursor is placed in an organic solution, such as an alcohol-based solution. The organic solvent may be an aliphatic or aromatic monoalcohol, or a diol.

The sol-gel solution may also contain a catalyst and/or water, or compounds that act on porosity, such as a surfactant.

According to one embodiment, which particularly concerns cell culture applications, the sol-gel solution comprises a functionalizing compound, in particular an organic compound, whose function is to form a grafting agent. The term grafting agent is intended to mean a molecule or functional group capable of promoting an attachment, by grafting, of a chemical or biological element to the surface of the xerogel resulting from the sol-gel method. The chemical or biological element is predetermined. It may be a molecule, a cell, or a protein or other organic 10 compound, such as a growth factor or antibody. For cell culture applications, the grafting agent promotes grafting of a cell of a predetermined type. The grafting agent may then be collagen, or polylysine or a milk protein. However, due to regulatory or quality control constraints, it is sometimes preferable to avoid molecules of animal origin. It is therefore possible to use a functionalization compound with an epoxy function, the latter being suitable for the formation of chemical bonds with amine functions, the latter being present in most cell membranes. The incorporation of an epoxy function can be carried out via a compound of glycidoxypropyltrimethoxysilane type, usually denoted by the acronym GPTM. An amine function can also be incorporated into the sol-gel, by means of an APTES-type compound (3-aminopropyl-triethoxysilane). An amine function can also be integrated into the sol-gel, by means of a compound of APTES (3-aminopropyltriethoxysilane) type. Such a compound allows a formation of positive charges at the surface of the beads, which promotes attachment of cells having surface negative charges. An amine function is suitable for the formation of peptide bonds with the amino acids of the cell wall.

The possibility of adding a functionalization compound to the sol-gel solution constitutes a valuable advantage, since it avoids performing a post-production functionalization, which is required in the prior art beads. This makes it possible to produce microcarriers specific to a predefined application, taking into account the chemical or biological element intended to be attached to the beads, and/or the medium in which the bead is intended to be placed.

The sol-gel solution can also include an active compound conferring particular properties to the beads to be formed. These may include optical properties, such as a particular color, in which case the sol-gel solution may comprise an ink. It may also involve an ability to generate fluorescent light. In the latter case, the sol-gel solution comprises fluorescent agents. The sol-gel solution may comprise agents conferring light-scattering properties, for example titanium oxide particles. This produces beads that scatter light.

The sol-gel solution may include agents for adjusting the dielectric or electrical properties, or the light-reflecting properties. The beads can comprise electrically conductive particles, and so be used to form an electromagnetic shield.

The sol-gel solution may comprise a compound whose optical properties change in the presence of a chemical or biological species. The beads formed from the solution can then be used in a sensor for said chemical or biological species.

The sol-gel solution may contain an agent that influences electrical conductivity. This may be conductive particles, such as metallic particles.

The resulting sol-gel beads can have a density generally below 2, and preferably below 1.8. The density is preferably strictly above 1 and advantageously between 1 and 1.4 and even more advantageously between 1.02 and 1.04. Such a density confers good flotation on the microcarriers in aqueous culture medium.

It is also possible to increase density, for example:
by reducing porosity, via reducing the amount of solvent and water in the sol;
by adding metal oxides with a higher density than glass, or by adding dense particles such as lead, gold or tungsten: for example, titanium oxide (density 4.23 g/cm³), alumina oxide (density 3.95 g/cm³), tin oxide (density 6.95 g/cm³) or zirconia oxide (density 5.68 g/cm³).

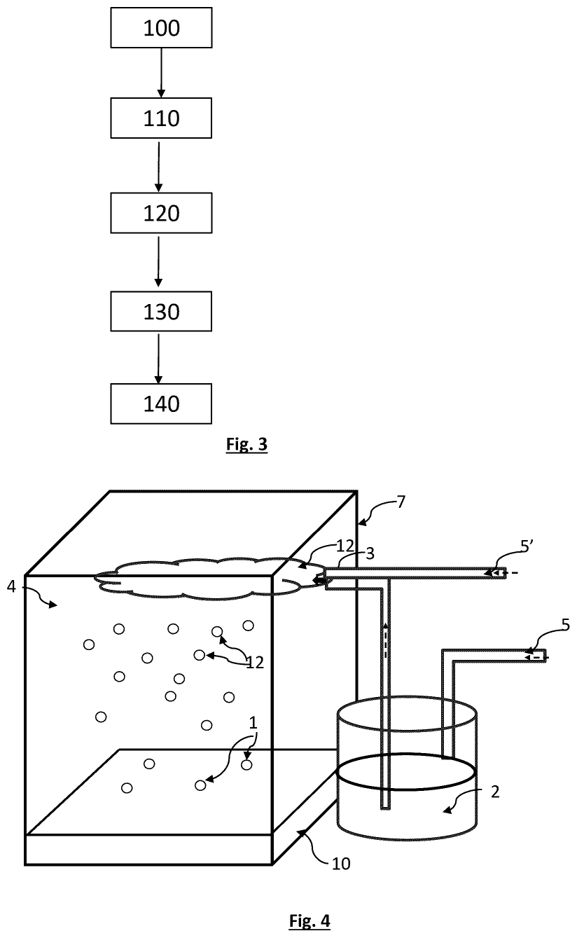

A first example of a sol-gel bead manufacturing method is now described with reference to FIG. 2. The main steps are shown in FIG. 3.

### Stage 100: Droplet Formation

A sol-gel solution 2, as described above, is introduced into a dispenser 3, such as a nebulizer or sprayer, to form droplets 12, and preferably calibrated drops. The drops 12 are preferably microdroplets, with a volume of between 10⁻⁵ nL and a few ml or tens of ml. For example, assuming a diameter of 2 μm, the droplet volume is 3.35 10⁻⁵ nL

Dispenser 3 may be a commercial spray or nebulizer device. In the example shown, drops are formed by applying pressure pulses to the sol-gel solution, up to a nozzle. The pressure pulses are applied by a propellant gas 5. The dispenser can be configured to form drops of calibrated size. Drops can be formed successively or simultaneously.

The dispenser enables drops 12 of sol-gel solution to be formed. The geometric characteristics of the droplets, in particular their diameter, depend on the choice of nozzle for dispenser 3, as well as on the viscosity of the sol-gel solution 2 and the liquid flow rate It is generally assumed that the lower the flow rate, the smaller the diameter.

Mixing air at the dispenser nozzle (“air mixed” dispenser) enables the formation of small beads, on the order of a few μm to a few tens of microns. Without air mixing (“air less” dispenser), the nozzle allows the formation of larger beads. FIG. 4 illustrates one such example: a feed gas 5′, such as air, is added to the nozzle.

The nozzle is placed at a distance from a receptacle 10. The receptacle may be a solid plate, preferably a hydrophobic plate, or a reservoir containing a liquid, e.g. water, or an oil, e.g. silicone oil.

The diameter of drops 12 formed by dispenser 3 at the nozzle outlet is preferably between 100 nm and 5 mm, or between 100 nm and 1 mm. Diameters of up to 10 mm or 20 mm are also possible

### Stage 110: Gelation and Drying.

Following step 110, the droplets 12 formed by dispenser 3 are directed towards the receptacle 10, through a gaseous medium 4 extending between dispenser 3 and receptacle 10. The gaseous medium may, for example, be air, or predominantly air.

The gaseous medium through which the droplets move can be confined in a chamber 7. The temperature and/or pressure in the chamber can be adjusted to promote gelation of the droplets 12. The movement of the droplets towards the receptacle 10 can be spontaneous, for example by gravity, which is the preferred method. The movement of the droplets 12 towards the receptacle 10 can be forced, for example by driving the gaseous medium towards the receptacle, resulting in a movement of the droplets towards the receptacle. The flow can also be opposed to the spontaneous movement of the droplets: this increases the duration of the droplets movement in the gaseous medium. The longer the travel time, the more advanced gelation and drying are when the drops reach the receptacle.

Between the dispenser 3 and the receptacle 10, the drops undergo gelation and drying, leading to solidification. The duration of the movement of drops 12 between dispenser 3 and receptacle 10 is calculated so that the drops reach the receptacle when the gelation phase has advanced sufficiently for the drops to be in a sufficiently solid state not to spontaneously deform or break when they reach the receptacle. Thus, and this is an important aspect of the invention, the drops are not deformed, or only negligibly, upon contact with the receptacle.

As the drops move through the gaseous medium 4 towards the receptacle 10, they gradually solidify as the sol-gel solution gels and dries. They then take on the shape of beads. In this example, the beads are solid.

### Step 120. Extraction

During this step, the beads 1 deposited on or in the receptacle 10 are extracted. Step 120 may include an additional drying phase for the material forming each bead. The use of a solid and preferably hydrophobic receptacle facilitates bead recovery, by avoiding the formation of OH bonds between the beads resulting from the method and the receptacle 10.

The beads 1 can be collected using a recovery support, preferably flexible, such as a fabric. This may be a porous nylon filter. The porosity of the recovery support can be optimized to retain the beads 1 while allowing the removal of undersized beads or debris, the latter passing through the recovery support. For example, when the diameter (or largest diagonal) of the beads is equal to 600 μm, the recovery support can have a 400 μm mesh. When the bead diameter is 200 μm, the mesh can be 150 μm.

### Stage 130: Washing

The beads collected in step 120 and placed on the recovery support are washed, for example by bathing in a washing solution to remove any residual acids present in the sol-gel solution or any unreacted precursors. The washing solution may be an aqueous solution, for example an aqueous solution containing 50% by weight of isopropanol. The method may comprise several successive baths, for example two or three successive baths.

### Stage 140: Post-Wash Drying

Following step 130, the beads are dried. Drying can be carried out at room temperature or at a higher temperature, for example up to 100° C. or higher. The drying temperature can be lowered if a partial vacuum is formed around the beads. During drying, the beads can be placed on the recovery support and the whole assembly is placed in an oven.

If required, the beads undergo a post-drying heat treatment.

In one variant, dispenser 3 is configured to produce hollow drops, or bubbles, i.e. drops formed by a spherical film of sol-gel solution containing a gas. Bubble production is facilitated by the use of a surfactant in the sol-gel solution. The surfactant may be a polyethylene (40) stearate or hexadecyltrimethyliammonium. The weight fraction of surfactant is preferably less than 5% and can be between 0.5% and 5%.

While droplets travel from the dispenser 3 to the receptacle 10, the bubbles gradually solidify by gelation/drying to form hollow beads. The hollow beads reach the receptacle in solid form. The use of a receptacle containing a liquid reduces the risk of damage to the hollow beads when they reach the receptacle.

An important aspect of the invention is that when the beads 1 reach the receptacle 10, they are sufficiently solid to be considered non-deformable. Unlike the method described in WO2021/140129, the beads reaching the receptacle do not deform on the latter. The main difference between the method described in WO2021/140129 and the method described in the present invention lies in the time taken for drops 12 to travel between dispenser 3 and receptacle 10. In WO2021/140129, the distance between dispenser and receptacle is small enough to allow the drops, upon reaching the receptacle, to be deformed under their own weight, so as to flatten out. In WO2021/140129, the distance between dispenser and receptacle is preferably less than 10 cm. In contrast, in the present invention, the drops, whether solid or hollow, reach the receptacle having solidified so that they are no longer deformable under their own weight, i.e. in the absence of external force.

The distance between receptacle 10 and dispenser 3 is preferably strictly greater than 10 cm, or even greater than 15 cm or 20 cm. It can be as much as several meters.

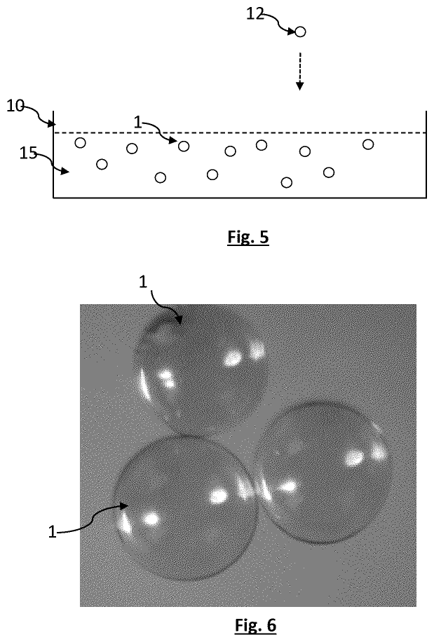

In one embodiment, shown in FIG. 5, the receptacle may contain a liquid 15. Liquid 15 may comprise a gelling agent, so as complete the gelation. The liquid may be, for example, a silicone or an oil or water. In this case, the beads may reach the receptacle while they are not solidified: they are then deformable. This type of design is particularly suited to the manufacture of hollow beads. The latter are more fragile when they reach the receptacle. The use of a liquid 15, within the receptacle, reduces the risk of bead breakage. Gelation can be carried out or continued in the liquid. For example, the liquid 15 may contain an agent that promotes gelation. In this embodiment, the distance between the dispenser forming the drops and the receptacle can be small, for example of the order of a few cm, or less than 1 cm.

Drying can take place after the beads have been extracted from the liquid. When the liquid is an oil or silicone, drying can be carried out in the liquid.

The gaseous medium extending between dispenser 3 and receptacle 10 can be configured to promote rapid gelation of sol-gel drops. The enclosure may be placed under partial vacuum, or heated to a temperature, for example 40° C., to enhance gelation. The gaseous medium may comprise one or more gelling-promoting compounds, such as ammonia vapor, or a gas containing an amine function, such as methylamine. Enclosure 7 can also be saturated with steam. Accelerating the gelation method reduces the travel time of drops between dispenser 3 and receptacle 10. This reduces the distance between dispenser 3 and receptacle 10: the method can be implemented using a more compact device.

### Experimental Trials.

Trials were carried out to produce solid beads. The experimental conditions were:

Dispenser 3: Vermes MDV 3200 A metering valve with Vermes N11-150 nozzle for forming sol-gel microdroplets.

Receptacle 10: laboratory floor: concrete covered with plastic sheeting.

Distance between receptacle 10 and distributor 3:4.5 meters.

1 Precursor: 98% Tetramethoxysilane (Alfa Aesar).
Solvent: Technical Isopropanol (Alfa Aesar).

Catalyst: 6M HCl (Sigma Aldrich).

Mineral functionalization compound: Hydroxyapatite Ca5 (OH)(PO₄)₃ (Sigma Aldrich). 1
Organic functionalization compound: Type 1 bovine collagen: 10 mg/ml (Vornia Ltd). 10 ml tetramethoxysilane was poured into a 50-ml beaker and kept stirring at room temperature. A 5 ml solution of deionized water was prepared, to which 0.1 ml of HCl was added. The solution was slowly poured into the beaker containing the tetramethoxysilane (10 ml). As tetramethoxysilane hydrolysis is exothermic, the water+HCl mixture was poured in at a rate of 2.5 ml/min.

5 ml isopropanol was then added to the beaker, followed by 1 ml hydroxyapatite solution. The hydroxyapatite solution was obtained by dissolving 200 mg hydroxyapatite powder in 2.5 ml deionised water and 0.5 ml HCl, HCl facilitating dissolution of the hydroxyapatite powder. 2 ml of collagen solution was also added.

The sol-gel solution, the preparation of which is described in the previous paragraph, was introduced into a syringe of the metering valve, whose setting parameters are as follows: rising: 0.55 ms; falling: 0.75 ms; open time: 0 ms; needle lift: 30; delay: 7 ms; air pressure: 0.5 bar. These parameters are adjusted on a case-by-case basis by those skilled in the art.

The gaseous medium separating the dispenser from the receptacle was air, at a temperature of 40° C., to promote gelation and drying of the drops. The volume of drops formed by the dispenser was 5 nL (nanoliters).

The beads formed were placed on a porous nylon filter, in order to eliminate beads of too small a size, resulting from the formation of satellite drops by the nozzle. The pores measured 120 μm in diameter. The porous filter, retaining the beads, was placed in a crystallizer, containing isopropanol diluted to 50% (mass fraction) in deionized water, in order to perform a wash. Washing time was 1 h30. Washing was repeated three times. Following the washes, the bead-retaining filter was dried in an oven at 100° C. for 1 h30.

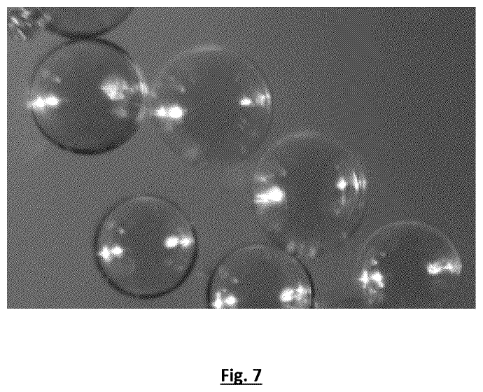

This produced solid beads with a diameter of 120 μm, an image of which is shown in FIG. 6.

Trials were carried out to produce hollow beads. The experimental conditions are described below:
Dispenser 3: household spray.
Receptacle 10: laboratory floor: concrete covered with plastic sheeting.
Distance between receptacle 10 and distributor 3:4.5 metres
Precursor: Tetramethoxysilane 98% (Alfa Aesar).
Solvent: Isopropanol Technical (Alfa Aesar).
Catalyst: 6M HCl (Sigma Aldrich).
Surfactant: cetyl-methylammonium bromide (Hexadecytrimethyl-ammonium bromide).
Inorganic functionalization compound: Hydroxyapatite Ca5 (OH) (PO₄)₃ (Sigma Aldrich).
Organic functionalization compound: Type 1 bovine collagen: 10 mg/ml (Vornia Ltd). 10 ml tetramethoxysilane was poured into a 50-ml beaker and kept stirring at room temperature. A 5 ml solution of deionized water was prepared, to which 0.1 ml of HCl was added. The solution was poured slowly into the beaker containing the tetramethoxysilane (10 ml). As tetramethoxysilane hydrolysis is exothermic, the water+HCl mixture was poured in at a rate of 2.5 ml/min. At the end of the reaction, 10 mL of distilled water containing 30 mg of Hexadecyltrimethyl-ammonium was added. 5 mL isopropanol was then added to the beaker.

The gaseous medium separating the dispenser from the receptacle was air, at a temperature of 40° C., to promote gelation and drying of the drops. The volume of drops formed by the dispenser was 35 nL (nanoliters).

The hollow beads formed were placed on a porous nylon filter, to eliminate beads of too small a size, resulting from the formation of satellite drops by the nozzle. The pores measured 160 μm in diameter.

FIG. 7 shows an example of the hollow beads obtained.

The beads, whether solid or hollow, resulting from the method can be used for a variety of purposes: for example, the manufacture of optical elements (fluorescent beads, scattering beads, fluorescent beads), or the manufacture of sensors (beads containing active principles whose optical properties are modified in the presence of a chemical or biological species).

The beads can be integrated into a matrix, such as a polymer, to modify the mechanical properties of the matrix. For example, integrating beads into a polymer can increase compressive strength. The weight of the polymer can also be reduced. The polymer may, for example, be a polymer as described in U.S. Pat. No. 11,091,638. Such a polymer is referred to as a “rheoplex polymer”. Its viscosity increases almost instantaneously under the effect of an impact. Thus, in its “normal” state, this type of polymer is relatively flexible, whereas under the effect of an impact, the polymer hardens instantaneously. The addition of beads improves compressive strength.

1. A method for forming beads by a sol-gel method, comprising:
a) forming liquid droplets from a sol-gel solution, the drops being formed at a distance from a receptacle;
b) following the forming of the liquid droplets a), of moving the liquid droplets through a gaseous medium, to the receptacle, the gaseous medium being conducive to gelation and drying of the droplets, thereby solidifying progressively when moving towards the receptacle, to form beads;
c) collecting the beads on the receptacle, a time taken by the droplets to travel through the gaseous medium being adjusted so that the beads are sufficiently solidified not to deform under their own weight when reaching the receptacle; and
d) collecting the beads from the receptacle.

2. The method according to claim 1, comprising a complementary drying phase e) for each bead on the receptacle.

3. The method according to claim 1, wherein the gaseous medium comprises air.

4. The method according to claim 1, wherein the gaseous medium is placed under partial vacuum.

5. The method according to claim 1, wherein, during the forming of the liquid droplets a),
each droplet is expelled through a nozzle of a dispenser; and
a feed gas is added to the sol-gel solution in the nozzle.

6. The method according to claim 1, wherein, in the forming of the liquid droplets a), a diameter of each droplet is less than 10 mm.

7. The method according to claim 1, wherein, in the forming of the liquid droplets a), a diameter of each drop-droplet is greater than 100 nm.

8. The method according to claim 1, wherein the forming of the liquid droplets a) is carried out by spraying or nebulization.

9. Method according to claim 1, wherein the gelation and drying are carried out at a temperature below 100° C.

10. The method according to claim 1, wherein:
in the forming of the liquid droplets a), the sol-gel solution contains a surfactant, with each droplet formed being hollow forming a sol-gel solution bubble, and
the moving of the liquid droplets through the gaseous medium b) results in formation of hollow beads.

11. The method according to claim 10, wherein a mass fraction of the surfactant is less than 5%.

12. The method according to claim 11, wherein the mass fraction of the surfactant is between 0.5% to 5%.

13. The method according to claim 6, wherein, in the forming of the liquid droplets a), a diameter of each droplet is less than 2 mm.

14. The method according to claim 13, wherein, in the forming of the liquid droplets a), a diameter of each droplet is less than 1 mm.

15. The method according to claim 2, wherein the gaseous medium comprises air.

16. The method according to claim 2, wherein the gaseous medium is placed under partial vacuum.

17. The method according to claim 3, wherein the gaseous medium is placed under partial vacuum.

18. The method according to claim 2, wherein, during the forming of the liquid droplets a),
each droplet is expelled through a nozzle of a dispenser;
a feed gas is added to the sol-gel solution in the nozzle.

19. A sol-gel bead, obtained by performing the method according to claim 1.

20. A hollow sol-gel bead, obtained by applying the method according to claim 10.
